(19) United States
(12) Patent Application Publication
(10) Pub. No.: US 2017/0175661 A1
(43) Pub. Date: Jun. 22, 2017

(54) REAL TIME DETECTION AND DIAGNOSIS OF CHANGE IN PEAK FIRING PRESSURE

(71) Applicant: General Electric Company, Schenectady, NY (US)

(72) Inventors: Chandan Kumar, Bangalore (IN); Pavan Chakravarthy Nandigama, Bangalore (IN); Amit Shrivastava, Bangalore (IN); Jeffrey Jacob Bizub, Milwauke, WI (US)

(21) Appl. No.: 14/977,226

(22) Filed: Dec. 21, 2015

(51) Int. Cl. F02D 41/22; G01M 15/08; F02D 41/14; G01L 23/22; F02B 77/08; F02D 35/02

(52) U.S. Cl. CPC F02D 41/22; F02B 77/085; F02D 35/023; F02D 35/027; F02D 41/1454; G01L 23/221; G01M 15/08; F02D 2200/70; F02D 2200/1002

(57) ABSTRACT

A control system includes a first and second sensor configured to monitor a first type of operating condition of a first and second cylinder of an engine, respectively, a feedback component configured to monitor a second type of operating condition of the engine, and a controller communicatively coupled with the first and second sensors and feedback component. The controller is configured to receive a first measurement of the first type of operating condition from the first sensor, a second measurement of the first type of operating condition from the second sensor, and a third measurement of the second type of operating condition from the feedback component, to analyze the first and second measurements to detect a change in operating peak firing pressure in the first cylinder and/or in the second cylinder, and to analyze the third measurement to diagnose a cause of the change.

### BACKGROUND OF THE PRESENT DISCLOSURE

The subject matter disclosed herein relates to fuel combusting engines and, more specifically, to a system and method for detecting a change in operating peak firing pressure in one or more cylinders of the fuel combusting engine, and diagnosing a cause of the change in operating peak firing pressure.

Combustion engines typically combust a carbonaceous fuel, such as natural gas, gasoline, diesel, and the like, and use the corresponding expansion of high temperature and pressure gases to apply a force to certain components of the engine, e.g., a piston disposed in a cylinder of the engine, to move the components over a distance. In traditional configurations, timing of combustion during operation of the combustion engine may be monitored and estimated using traditional techniques. Traditional techniques may also be used for detecting certain other operating events and conditions (e.g., operating peak firing pressure) of the combustion engine. However, traditional monitoring techniques may not be accurate, and corrective measures utilizing the traditional monitoring techniques may reduce an efficiency of the internal combustion engine. Accordingly, improved monitoring, detection, and diagnosing of operating events and conditions, such as operating peak firing pressure, may be useful.

### BRIEF DESCRIPTION

Certain embodiments commensurate in scope with the originally claimed invention are summarized below. These embodiments are not intended to limit the scope of the claimed invention, but rather these embodiments are intended only to provide a brief summary of possible forms of the present disclosure. Indeed, the present disclosure may encompass a variety of forms that may be similar to or different from the embodiments set forth below.

In a first embodiment, a system includes a control system configured to monitor operating conditions in at least a first cylinder and a second cylinder of a reciprocating engine. The control system includes a first sensor configured to monitor a first type of operating condition of the first cylinder, a second sensor configured to monitor the first type of operating condition of the second cylinder, and at least one feedback component configured to monitor a second type of operating condition of the reciprocating engine. The control system also includes a controller communicatively coupled with the first sensor, the second sensor, and the at least one feedback component. The controller is configured to receive a first signal indicative of a first measurement of the first type of operating condition from the first sensor, a second signal indicative of a second measurement of the first type of operating condition from the second sensor, and at least a third signal indicative of a third measurement of the second type of operating condition of the reciprocating engine. The controller is configured to analyze the first and second signals to detect a change in operating peak firing pressure in the first cylinder, the second cylinder, or in a combination thereof, and the controller is configured to analyze the third signal to diagnose a cause of the change in operating peak firing pressure in the first cylinder, in the second cylinder, or in the combination thereof.

In a second embodiment, a method of monitoring cylinders of an engine includes receiving, via an engine controller, a group of signals indicative of a first operating condition in the cylinders of the engine, determining, via the engine controller, whether the group of signals indicative of the first operating condition in the cylinders of the engine indicate a change in operating peak firing pressures in one or more cylinders of the engine, receiving, via the engine controller, at least one second signal indicative of a second operating condition of the engine, and diagnosing, via the engine controller analyzing the at least one second signal, a cause of the change in operating peak firing pressures in the one or more cylinders of the engine.

In a third embodiment, a control system includes a first group of sensors configured to monitor a first operating condition in a corresponding group of cylinders of a reciprocating engine. The control system also includes a controller communicatively coupled with the first group of sensors. The controller is configured to receive a first group of signals indicative of the first operating condition from the first group of sensors, to receive at least one second signal indicative of at least one second operating condition of the reciprocating engine, to analyze the first group of signals to detect a change in operating peak firing pressure in one or more cylinders of the group of cylinders, and to analyze the at least one second signal indicative of the at least one second operating condition of the reciprocating engine to diagnose a cause of the change in operating peak firing pressure in the one or more cylinders of the group of cylinders.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an embodiment of a portion of a reciprocating engine driven power generation system, in accordance with aspects of the present disclosure;

FIG. 2 is a side cross-sectional view of an embodiment of a piston assembly within a cylinder of the reciprocating engine shown in FIG. 1, in accordance with aspects of the present disclosure;

FIG. 3 is a front view of an embodiment of a group of cylinders for use in the reciprocating engine shown in FIG. 1 and a corresponding control system, in accordance with aspects of the present disclosure;

FIGS. 4A and 4B are first and second sections, respectively, of a flow diagram of an embodiment of a process suitable for detecting a change in operating peak firing pressure in the reciprocating engine of FIG. 1 and diagnosing a cause of the change in operating peak firing pressure, in accordance with an aspect of the present disclosure; and

FIG. 5 is a flow diagram of an embodiment of a process, in some embodiments continuing form the process illustrated in FIGS. 4A and 4B, suitable for diagnosing a cause of a change in operating peak firing pressure, in accordance with an aspect of the present disclosure.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The present disclosure is directed to reciprocating engines and, more specifically, to detection of changes (e.g., rises) in operating firing pressure (e.g., operating peak firing pressure). In particular, the present disclosure is directed to detection of changes in an operating peak firing pressure (e.g., a maximum pressure within a cylinder of the reciprocating engine over the course of one cycle of the piston assembly, as described below) in one or more cylinders of the reciprocating engine. The present disclosure is also directed to diagnosing a cause of the change in operating peak firing pressure by using a feedback component (e.g., a sensor or multiple sensors), a controller, and/or other components of a control system of the reciprocating engine. For example, the reciprocating engine, which will be described in detail below with reference to the figures, includes a cylinder and a piston disposed within the cylinder (or multiple cylinders, each having a corresponding piston disposed within the cylinder). The reciprocating engine includes an internal combustion engine, such as a spark ignition engine or compression-ignition engine (e.g., a diesel engine). The reciprocating engine also includes an ignition feature that ignites a fuel-oxidant (e.g., fuel-air) mixture within a combustion chamber proximate to the piston (e.g., within the cylinder and above the piston). The hot combustion gases generated from ignition of the fuel-air mixture drive the piston within the cylinder. In particular, the hot combustion gases expand and exert a pressure against the piston that linearly moves the position of the piston from a top portion to a bottom portion of the cylinder during an expansion stroke. The piston converts the pressure exerted by the hot combustion gases (and the piston's linear motion) into a rotating motion (e.g., via a connecting rod coupled to, and extending between, the piston and a crankshaft) that drives one or more loads, e.g., an electrical generator. The piston may then move toward the combustion chamber as more air and fuel is injected into the combustion chamber, such that the piston compresses the fuel-air mixture prior to ignition. This process is repeated in cycles, as described below, and a pressure within each cylinder fluctuates during each cycle. The maximum pressure of each cycle is referred to as the operating peak firing pressure of the cycle.

Generally, the reciprocating engine includes an ignition feature or mechanism (e.g., a spark plug) that ignites the fuel-air mixture within the combustion chamber as the piston moves upwardly toward the top portion of the cylinder. For example, the spark plug may ignite the fuel-air mixture when the crank angle of the crankshaft is approximately 5-35 degrees from top dead center (TDC), where TDC is a “highest” position of the piston within the cylinder. Improved timing of the ignition (e.g., such that ignition occurs at a particular moment during a cycle of the engine) may improve performance of the reciprocating engine. For example, poor timing of the ignition may cause pre-ignition (e.g., engine knocking, pinging), which describes a condition in which pockets of the fuel-air mixture combust outside an envelope of a primary combustion front. Pre-ignition may significantly reduce recovery of work (e.g., by the piston) from the expanding combustion gases.

Thus, in accordance with the present disclosure, one or more feedback components (e.g., sensors such as a crankshaft sensor, a knock sensor, an air sensor, or a combination thereof) is included in, or proximate to, each cylinder (or certain cylinders) of the reciprocating engine, and may be communicatively coupled to a controller. The air sensor may be positioned proximate to any component of the reciprocating engine, and in certain embodiments, only one air sensor is used (e.g., in some embodiments, each cylinder does not include a separate air sensor). As used herein, the term knock sensor may include any suitable vibration sensor, acoustic sensor, or other sensor, or a combination thereof, which may or may not be used to detect knock (e.g., pre-ignition) in the engine. As used herein, the term crankshaft sensor may include any suitable position sensor, optical sensor, rotational speed sensor, or other sensor, or a combination thereof, which may be used to monitor a position of a crankshaft of the reciprocating engine (e.g., such that the position of the crankshaft may be correlated with ignition timing). As used herein, the term air sensor may include any suitable sensor used to detect an amount of oxygen in, or absent in, a fluid such as air (e.g., measured as a volume ratio of the fluid, a pressure ratio of the fluid, a volume of the oxygen, a pressure of the oxygen, or any other suitable measurement), a temperature of the fluid such as air, a pressure of the fluid, or some other measurement of the fluid.

In accordance with the present disclosure, a controller may receive signals from the knock sensor, the crankshaft sensor, the air sensor, and/or other feedback components of the reciprocating engine. The controller may analyze the signals to detect a change (e.g., rise) in operating peak firing pressure in one or more of the associated cylinders, and to diagnose a cause of the change in operating peak firing pressure in the one or more associated cylinders. For example, the controller may analyze the signals to determine how many, and which, cylinders include a change (e.g., rise) in operating peak firing pressure, and/or a cause for the change. As will be appreciated in view of the discussion below, the controller may analyze two or more signals indicative of two or more operating conditions (e.g., vibration or knock, position of the crankshaft sensor, ambient air conditions, oxygen content in exhaust, etc.) of the reciprocating engine and/or associated cylinders to fully diagnose the cause of the change in operating peak firing pressure in the one or more associated cylinders. For example, the controller may analyze signals from knock sensors and from crankshaft sensors to diagnose the cause of the change in operating peak firing pressure in the one or more associated cylinders (e.g., as being related to oil or fuel coking, compression ratio changes, or fuel quality improvement or decline). Additionally or alternatively, the controller may analyze signals from knock sensors and from air sensors (or from a single air sensor) to diagnose the cause of the change in operating peak firing pressure in the one or more associated cylinders (e.g., as being related to ambient air conditions or to a ratio of the air-fuel mixture). Additionally or alternatively, the controller may analyze signals from crankshaft sensors and from air sensors (or from one air sensor) to diagnose the cause of the change in operating peak firing pressure in the one or more associated cylinders (e.g., as being related to ambient air conditions or to a ratio of the air-fuel mixture). Additionally or alternatively, the controller may analyze signals from knock sensors (or from crankshaft sensors) and from a component that monitors an amount of electrical load drawn from the reciprocating engine (e.g., into a power grid), to diagnose the cause of the change in operating peak firing pressure in the one or more associated cylinders (e.g., as being related to electrical loading). These and other features will be described in detail below, with reference to the figures.

Generally, a baseline peak firing pressure is determined for each cylinder of the reciprocating engine by the manufacturer before installation and operational use, such that operating peak firing pressures may be compared with the baseline peak firing pressure to determine whether the operating peak firing pressure is too high. In some embodiments, the baseline peak firing pressure may be the same for each cylinder. To determine a baseline peak firing pressure, the engine system may be operated to full load and data captured via the sensor(s) may be logged. The logged data may then be processed into one or more curves or graphs indicative of the baseline peak firing pressure. For example, noise level as a function of time may be used as one of the curves, as well as noise frequency, noise phase, noise amplitude, and so on. Such curve(s) are then considered baseline curves representative of the baseline peak firing pressure. It should be noted, however, that the curves may be determined without generating a visual representation (e.g., a graph) of each curve.

While in one embodiment the baseline peak firing pressure may be determined, e.g., in a factory before the reciprocating engine is installed for normal use, in another embodiment the baseline peak firing pressure may be determined in situ after delivery of the engine to the customer. The reciprocating engine may be operated to achieve baseline peak firing pressure during each expansion stroke. For example, an increase in operating peak firing pressure above the baseline peak firing pressure may result in engine knocking (e.g., local pockets of combustion outside the primary combustion front) that reduces an efficiency of the reciprocating engine, as the piston may be unable to efficiently recover work from the expanding combustion gases.

It should also be noted that other baseline values of other parameters/conditions (e.g., ambient air conditions, oxygen content in exhaust from cylinder(s), electrical loading, etc.) may be determined or calculated by, or input to, the controller, such that the controller may compare operating values of the parameters/conditions with the baseline values to determine whether changes (e.g., rises) have occurred in the parameters/conditions, or to determine whether the operating values are desirably within range of the baseline values.

Accordingly, as previously described, a number of input signals (e.g., from knock sensors, crankshaft sensors, air sensors, etc.) may be analyzed (in addition to the baseline peak firing pressure curves) by the controller to detect a change in operating peak firing pressure in one or more of the cylinders and to diagnose a cause of the change in operating peak firing pressure. Other control logic may also be employed, and will be described in detail below with reference to the figures.

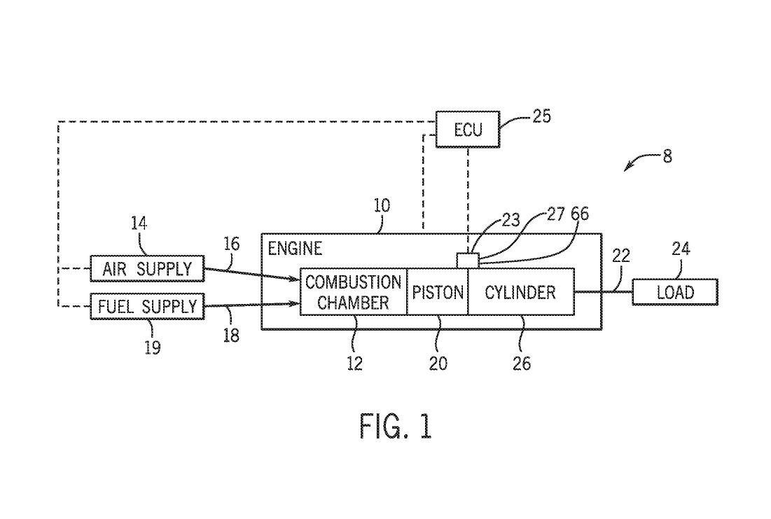

Turning to the drawings, FIG. 1 illustrates a block diagram of an embodiment of a portion of an engine driven power generation system 8. As described in detail below, the system 8 includes an engine 10 (e.g., a reciprocating internal combustion engine) having one or more combustion chambers 12 (e.g., 1, 2, 3, 4, 5, 6, 7, 8, 10, 12, 14, 16, 18, 20, or more combustion chambers 12). An air supply 14 is configured to provide a pressurized oxidant 16, such as air, oxygen, oxygen-enriched air, oxygen-reduced air, or any combination thereof, to each combustion chamber 12. The combustion chamber 12 is also configured to receive a fuel 18 (e.g., a liquid and/or gaseous fuel) from a fuel supply 19, and a fuel-air mixture ignites and combusts within each combustion chamber 12. The hot pressurized combustion gases cause a piston 20 adjacent to each combustion chamber 12 to move linearly within a cylinder 26 and convert pressure exerted by the gases into a rotating motion, which causes a shaft 22 to rotate. Further, the shaft 22 may be coupled to a load 24, which is powered via rotation of the shaft 22. For example, the load 24 may be any suitable device that may generate power via the rotational output of the system 10, such as an electrical generator. Additionally, although the following discussion refers to air as the oxidant 16, any suitable oxidant may be used with the disclosed embodiments. Similarly, the fuel 18 may be any suitable gaseous fuel, such as natural gas, associated petroleum gas, propane, biogas, sewage gas, landfill gas, coal mine gas, for example.

The system 8 disclosed herein may be adapted for use in stationary applications (e.g., in industrial power generating engines) or in mobile applications (e.g., in cars or aircraft). The engine 10 may be a two-stroke engine, three-stroke engine, four-stroke engine, five-stroke engine, or six-stroke engine. The engine 10 may also include any number of combustion chambers 12, pistons 20, and associated cylinders (e.g., 1-24). For example, in certain embodiments, the system 8 may include a large-scale industrial reciprocating engine having 4, 6, 8, 10, 16, 24 or more pistons 20 reciprocating in cylinders 26. In some such cases, the cylinders 26 and/or the pistons 20 may have a diameter of between approximately 13.5-34 centimeters (cm). In some embodiments, the cylinders and/or the pistons 20 may have a diameter of between approximately 10-40 cm, 15-25 cm, or about 15 cm. The system 10 may generate power ranging from 10 kW to 10 MW. In some embodiments, the engine 10 may operate at less than approximately 1800 revolutions per minute (RPM). In some embodiments, the engine 10 may operate at less than approximately 2000 RPM, 1900 RPM, 1700 RPM, 1600 RPM, 1500 RPM, 1400 RPM, 1300 RPM, 1200 RPM, 1000 RPM, 900 RPM, or 750 RPM. In some embodiments, the engine 10 may operate between approximately 750-2000 RPM, 900-1800 RPM, or 1000-1600 RPM. In some embodiments, the engine 10 may operate at approximately 1800 RPM, 1500 RPM, 1200 RPM, 1000 RPM, or 900 RPM. Exemplary engines 10 may include General Electric Company's Jenbacher Engines (e.g., Jenbacher Type 2, Type 3, Type 4, Type 6 or J920 FleXtra) or Waukesha Engines (e.g., Waukesha VGF, VHP, APG, 275GL), for example.

The driven power generation system 8 may include, for each cylinder 26, one or more knock sensors 23 suitable for detecting engine “knock.” The knock sensors 23 may be any sensors configured to sense sounds or vibrations caused by the engine 10, such as sound or vibration in the cylinders 26 of the engine 10 due to detonation, pre-ignition, and or pinging. The knock sensor 23 is shown communicatively coupled to an engine control unit (ECU) 25. During operations, signals from the knock sensor(s) 23 are communicated to the ECU 25 to determine if knocking conditions (e.g., pinging) exist. The ECU 25 may then adjust certain engine 10 parameters to ameliorate or eliminate the knocking conditions. For example, the ECU 25 may adjust ignition timing and/or adjust boost pressure to eliminate the knocking. As further described herein, the knock sensor 23 may additionally derive that certain sounds or vibrations should be further analyzed and categorized to detect, for example, engine conditions (e.g., pre-ignition or pinging).

The driven power generation system 8 may also include, for each cylinder 26, one or more crankshaft sensors 66 suitable for detecting, monitoring, or tracking a position of a crankshaft of the associated cylinder 26 or of the power generation system 8. For example, the power generation system 8 may include multiple crankshafts, each coupled to one or more cylinders 26, or the power generation system 8 may include only one crankshaft coupled to all the cylinders 26. Each of the crankshaft sensors 66 may monitor a position of the crankshaft, for example relative to a timing of ignition in each of the cylinders 26.

The driven power generation system 8 may also include a single air sensor 27 (or multiple air sensors 27) communicatively coupled with one or more of the cylinders 26 (e.g., a combustion chamber 12 within the cylinder 26), or with any other component of the engine 10. The air sensor 27 may detect ambient air conditions proximate to the engine 10. Additionally or alternatively, the system 8 may include one or more air sensors 27 that detect an amount of oxygen (e.g., a lambda sensor) in exhaust expelled from the cylinders 26 of the engine 10. In accordance with present embodiments, data from the knock sensors 23, the crankshaft sensors 66, the air sensor(s) 27, or a combination thereof may be analyzed by the controller 25 to detect a rise in operating peak firing pressure in one or more of the cylinders 26, in addition to a cause of the rise in operating peak firing pressure in the one or more cylinders 26. Further still, other data, as described below, may be analyzed by the controller 25 to detect the rise in operating peak firing pressure and to diagnose a reason for the rise in operating peak firing pressure.

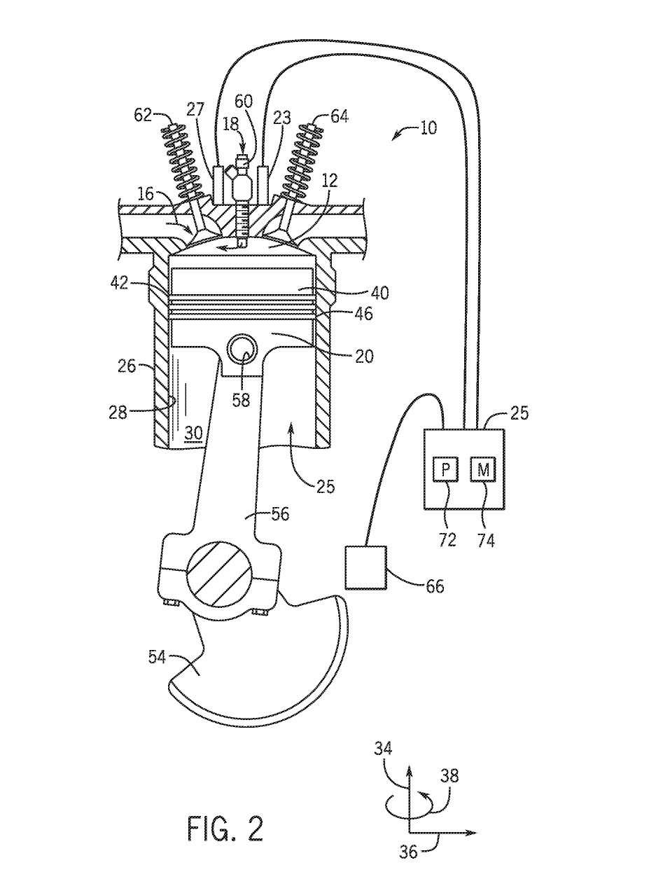

FIG. 2 is a side cross-sectional view of an embodiment of a piston assembly 25 having a piston 20 disposed within a cylinder 26 (e.g., an engine cylinder) of the reciprocating engine 10. For example, the reciprocating engine 10 of FIG. 1 may include one or more of the piston assemblies 25 (and associated cylinders 26) shown in FIG. 2. The illustrated cylinder 26 has an inner annular wall 28 defining a cylindrical cavity 30 (e.g., bore). The piston 20 may be defined by an axial axis or direction 34, a radial axis or direction 36, and a circumferential axis or direction 38. The piston 20 includes a top portion 40 (e.g., a top land). The top portion 40 generally blocks the fuel 18 and the air 16, or a fuel-air mixture 32, from escaping from the combustion chamber 12 during reciprocating motion of the piston 20.

As shown, the piston 20 is attached to a crankshaft 54 via a connecting rod 56 and a pin 58. The crankshaft 54 translates the reciprocating linear motion of the piston 24 into a rotating motion. As previously described, the engine 10 may include one or more crankshafts 54, each crankshaft being coupled to one piston assembly 25 or to multiple piston assemblies 25 (and associated cylinders 26) of the engine 10. As the piston 20 moves, the crankshaft 54 rotates to power the load 24 (shown in FIG. 1), as discussed above. As shown, the combustion chamber 12 is positioned adjacent to the top land 40 of the piston 24. A fuel injector 60 provides the fuel 18 to the combustion chamber 12, and an intake valve 62 controls the delivery of air 16 to the combustion chamber 12. An exhaust valve 64 controls discharge of exhaust from the engine 10. However, it should be understood that any suitable elements and/or techniques for providing fuel 18 and air 16 to the combustion chamber 12 and/or for discharging exhaust may be utilized, and in some embodiments, no fuel injection is used. In operation, combustion of the fuel 18 with the air 16 in the combustion chamber 12 cause the piston 20 to move in a reciprocating manner (e.g., back and forth) in the axial direction 34 within the cavity 30 of the cylinder 26.

During operations, when the piston 20 is at the highest point in the cylinder 26 it is in a position called top dead center (TDC). When the piston 20 is at its lowest point in the cylinder 26, it is in a position called bottom dead center (BDC). As the piston 20 moves from top to bottom or from bottom to top, the crankshaft 54 rotates one half of a revolution. Each movement of the piston 20 from top to bottom or from bottom to top is called a stroke, and engine 10 embodiments may include two-stroke engines, three-stroke engines, four-stroke engines, five-stroke engine, six-stroke engines, or more.

During engine 10 operations, a sequence including an intake process, a compression process, a power process, and an exhaust process occurs. The intake process enables a combustible mixture, such as fuel and air, to be pulled into the cylinder 26, thus the intake valve 62 is open and the exhaust valve 64 is closed. The compression process compresses the combustible mixture into a smaller space, so both the intake valve 62 and the exhaust valve 64 are closed. The power process ignites the compressed fuel-air mixture, which may include a spark ignition through a spark plug system, and/or a compression ignition through compression heat. The resulting pressure from combustion then forces the piston 20 to BDC. The exhaust process typically returns the piston 20 to TDC while keeping the exhaust valve 64 open. The exhaust process thus expels the combusted fuel-air mixture (e.g., combustion gases) through the exhaust valve 64. It is to be noted that more than one intake valve 62 and exhaust valve 64 may be used per cylinder 26.

The depicted engine 10 also includes the crankshaft sensor 66, the knock sensor 23, the air sensor 27, and the engine control unit (ECU) 25 from FIG. 1, which includes a processor 72 and a memory 74. The crankshaft sensor 66 may sense the position and/or rotational speed of the crankshaft 54. Accordingly, a crank angle or crank timing information may be derived in certain embodiments. That is, when monitoring combustion engines, timing is frequently expressed in terms of crankshaft 54 angle, which is correlative to time. For example, a full cycle of a four stroke engine 10 may be measured as a 720° cycle over a period of time. In some embodiments, the crankshaft sensor 66 may also detect an operating angular velocity of the crankshaft 54. A change in the operating angular velocity of the crankshaft 54 (e.g., such that the operating angular velocity is above a baseline, threshold, or desired value of the angular velocity) may be indicative of a change (e.g., rise) in peak firing pressure, as will be described in detail below with reference to later figures.

The knock sensor 23 may include one or more of a Piezo-electric accelerometer, a microelectromechanical system (MEMS) sensor, a Hall effect sensor, a magnetostrictive sensor, and/or any other sensor designed to sense vibration, acceleration, sound, and/or movement. In other embodiments, sensor 23 may not be a knock sensor in the traditional sense, but any sensor that may sense vibration, pressure, acceleration, deflection, or movement, and may not be used to detect engine “knock.”

The air sensor 27 may detect ambient air conditions around the cylinder 26 and/or the air sensor 27 may detect an amount of oxygen in an exhaust expelled from the cylinder 26. Ambient air conditions and amount of oxygen in the exhaust expelled from the cylinder 26 may include measurements relating to an amount (e.g., percentage) of oxygen in the air, a temperature of the air, a pressure of the air, or some other measurement of the air indicative of ambient air conditions and/or amounts of oxygen present in the air.

Because of the percussive nature of the engine 10, the knock sensor 23 may be capable of detecting signatures even when mounted on the exterior of the cylinder 26. However, the knock sensor(s) 23 may be disposed at various locations in or about each cylinder 26. Additionally, in some embodiments, a single knock sensor 23 may be shared, for example, with one or more adjacent cylinders 26. In other embodiments, each cylinder 26 may include one or more knock sensors 23. The crankshaft sensor 66 and the knock sensor 23 are shown in electronic communication with the engine control unit (ECU) 25. The ECU 25 includes the processor 72 and the memory 74. The memory 74 may store computer instructions that may be executed by the processor 72. The ECU 25 monitors and controls and operation of the engine 10, for example, by adjusting combustion timing, valve 62, 64, timing, adjusting the delivery of fuel and oxidant (e.g., air), and so on.

Each of the sensors 66, 23, 27 may transmit signals indicative of the respective operating conditions the sensors 66, 23, 27 are monitoring to the controller 25, which analyzes the signals to detect a change in operating peak firing pressure and to diagnose a cause of the change in peak firing pressure, as set forth below. That is, the techniques described herein may use the ECU 25 to receive data from the knock sensor 23 of each cylinder 26 (or a group of cylinders 26), the crankshaft sensor 66 of each cylinder 26 (or a group of cylinders 26), and the air sensor(s) 27. The ECU 25 may then go through the process of analyzing the data to determine operating conditions of the engine 10 and diagnose causes of abnormal or undesired operating conditions. For example, the ECU 25 may analyze one or more of the signals to detect a change (e.g., rise) in operating peak firing pressure in one or more of the cylinders, and an additional one or more signals to diagnose a cause of the change (e.g., rise) in operating peak firing pressure in the one or more of the cylinders.

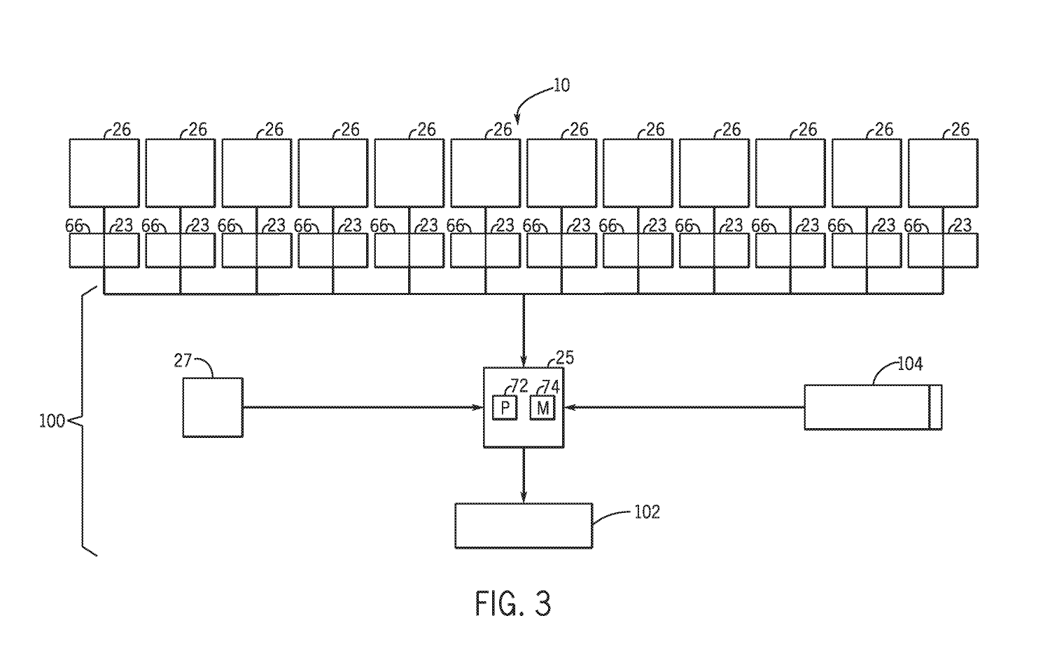

A schematic diagram of the reciprocating engine 10 of FIG. 1 (e.g., having twelve [12] cylinders 26) and a control system 100 having the controller 25 (e.g., ECU) of FIGS. 1 and 2 is shown in FIG. 3. It should be noted that the reciprocating engine 10 may include any number of cylinders 26. For example, the engine 10 may include 1, 2, 3, 4, 5, 6, 7, 8, 9, 10, 11, 12, 13, 14, or more cylinders 26. The control system 100 includes the controller 25, the knock sensors 23 and crankshaft sensors 66 associated with each of the cylinders 26 of the reciprocating engine 10, the air sensor 27, a display 102 (e.g., alert mechanism that alerts an operator of a change [e.g., rise] in operating peak firing pressure[s] and/or that alerts the operator of the cause of the change [e.g., rise] in operating peak firing pressure[s]), and an electrical load control feedback component 104 (e.g., a load sensor or other electrical load feedback component which detects an electrical load drawn from the reciprocating engine 10 to a load, such as a power grid). It should be noted that, in some embodiments, the control system 100 may include multiple air sensors 27, each air sensor 27 being associated with one cylinder 26 or with a subset of the cylinders 26 and configured to detect an amount of oxygen present in an exhaust of the associated cylinder(s) 26, as described below.

In accordance with embodiments of the present disclosure, each cylinder 26 is monitored by one knock sensor 23 and one crankshaft sensor 66. However, in some embodiments, each cylinder 26 is monitored by only a knock sensor 23 or only a crankshaft sensor 66. Further, in some embodiments, one knock sensor 23 and/or one crankshaft sensor 66 monitors multiple cylinders 26 (e.g., a subset of cylinders 26). In general, the knock sensors 23 and/or crankshaft sensors 66 sample operating conditions of the associated cylinder(s) 26, and transmit signals indicative of the corresponding operating conditions to the controller 25. For example, the knock sensor 23 may detect vibrations of the cylinder 26 (e.g., where the vibrations are indicative of varying pressures within the cylinder 26) or of components of the cylinder 26, and the crankshaft sensor 66 detects a position of a crankshaft coupled to a piston within the cylinder 26 via a connecting rod, as previously described.

The controller 25 receives the signals from the knock sensors 23 and/or the crankshaft sensors 66 and analyzes the signals to detect a change (e.g., rise) in peak firing pressure. For example, the controller 25 may analyze the signals from the knock sensors 23 to determine a peak firing pressure (e.g., maximum firing pressure over one cycle) of the associated cylinders 26. Thus, the controller 25 may detect changes (e.g., rises) in one or more of the associated cylinders 26 by analyzing the signals from the knock sensors 23. For example, the controller 25 may compare the determined operating peak firing pressure(s) (e.g., for each cylinder 26 separately, across multiple cycles of each cylinder 26), or the controller 25 may compare the operating peak firing pressure(s) with a baseline peak firing pressure (e.g., determined before, during, or after factory installation, as previously described) associated with the cylinder(s) 26. Accordingly, in certain embodiments, changes (e.g., rises) in peak firing pressure in one or more of the cylinders 26 may be detected by analyzing the signals from the knock sensors 23 only.

Further, in certain embodiments, changes (e.g., rises) in peak firing pressure in one or more of the cylinders 26 may be detected by analyzing the signals from the crankshaft sensors 66 only. For example, the crankshaft sensors 66 may be capable of monitoring angular velocity of the crankshafts in addition to, or in alternate of, a position of the crankshafts. By analyzing signals indicative of angular velocity of the crankshafts, the controller 25 may detect a change (e.g., rise) in peak firing pressure by determining changes (e.g., rises) in angular velocity (e.g., maximum angular velocity) of the crankshafts 54, relative to a baseline (e.g., threshold, maximum, desired, or maximum desired) angular velocity that may be determined prior to operation of the engine 10.

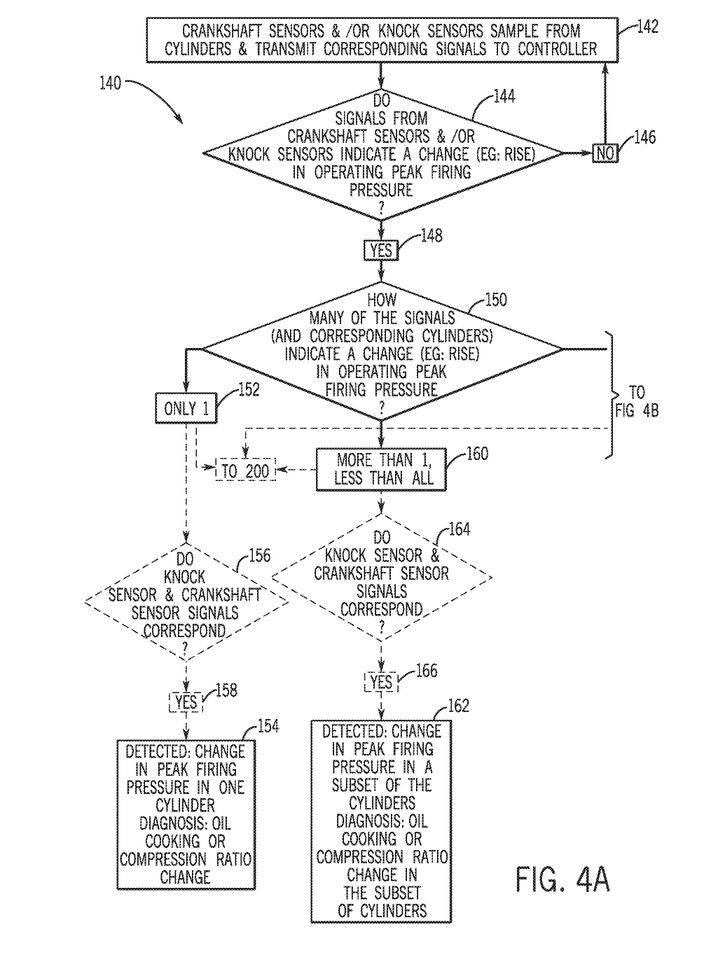

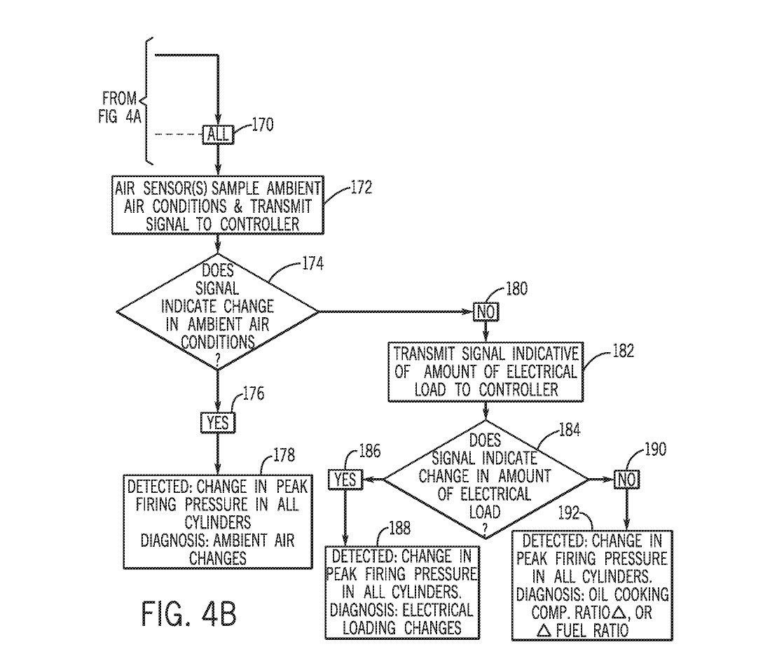

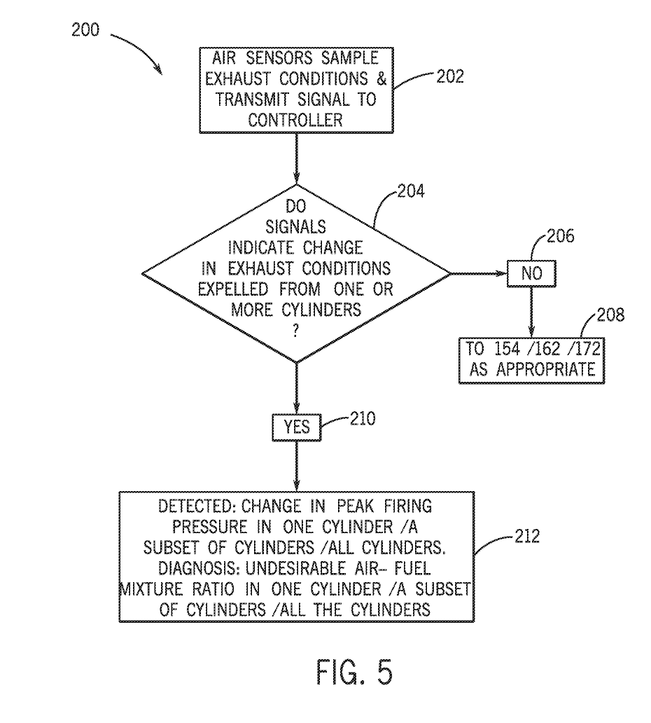

Further still, in some embodiments, the controller 25 (e.g., ECU) may analyze signals from the knock sensors 23 and from the crankshaft sensors 66 to detect changes (e.g., rises) in peak firing pressure, or to confirm the changes (e.g., rises) in peak firing pressures by correlating the knock sensors' 23 readings (e.g., data) with the crankshaft sensors' 66 readings (e.g., data). For example, the controller 25 may detect the changes (e.g., rises) in operating peak firing pressure in one or more of the cylinders 26 by analyzing the knock sensors' 23 signals, and may confirm the changes (e.g., rises) in peak firing pressure in the one or more cylinders 26 by analyzing the crankshaft sensors' 66 signals, in accordance with the description above. In some embodiments, as described below with respect to FIGS. 4 and 5, a cause of the change (e.g., rise) in operating peak firing pressure(s) may be diagnosed via the controller 25 analyzing only the crankshaft sensor 66 signals, only the knock sensor 23 signals, or both.

In accordance with present embodiments, the controller 25 may receive and analyze additional signals provided by other feedback components to diagnose a cause of the changes (e.g., rises) in peak firing pressure in one or more of the cylinders 26. For example, the controller 25 may receive a signal from one air sensor 27 that detects conditions of ambient air around the reciprocating engine 10. The air sensor 27 may, for example, detect pressure conditions, temperature conditions, or other ambient air conditions. The controller 25 may analyze the signals from the air sensor 27 and determine that certain changes (e.g., rises) in peak firing pressure in one or more of the cylinders 26 is caused by undesirable ambient air conditions. As previously described, the control system 100 may include multiple air sensors 27, each air sensor 27 being associated with one or more of the cylinders 26. Accordingly, the air sensors 27 may detect conditions of exhaust expelled from each of the cylinders 26. For example, the air sensors 27 may detect an amount of oxygen present in the exhaust, and may relay a signal indicative of the amount of oxygen present in the exhaust of each cylinder 26 (or of a subset of cylinders 26) to the controller 25. The controller 25 may analyze the signals to determine whether the conditions present in the exhaust are indicative of an undesirable ratio of air to fuel in the air-fuel mixture combusted in the associated cylinder(s) 26, which may cause a change (e.g., rise) in peak firing pressure. As previously described, data from the air sensor(s) 27 signals analyzed by the controller 25 may be compared by the controller 25 to baseline values of the ambient air conditions and/or to baseline values of desired oxygen content in exhaust.

Further still, the electrical load control feedback component 104 (e.g., electrical load sensor) may detect an amount of electrical charge drawn from the engine 10 by a load (e.g., by a power grid). The electrical load control feedback component 104 may be a sensor, or the electrical load control feedback component may be some other component (e.g., a bus bar) capable of interfacing with the controller 25 such that the controller 25 may determine an amount of electrical load drawn from the engine 10 (e.g., per unit of time, per cycle of each cylinder 26, etc.). Thus, the controller 25 may determine whether a change (e.g., rise) in the electrical load drawn from the engine 10 has occurred, and may diagnose the change (e.g., rise) in peak firing pressure in the cylinders 26 as being caused by the change (e.g., rise) in the electrical loading. Each of the detection and diagnoses described above, in addition to further iterations, are described in detail below, with reference to later figures.

FIG. 4A is a first section of an embodiment of a process 140 of detecting a change (e.g., rise) in operating peak firing pressure in one or more cylinders 26 of the reciprocating engine 10, and diagnosing a cause of the change (e.g., rise) in peak firing pressure. The process 140 includes sampling operating conditions of each of the cylinders 26, or subsets of the cylinders 26, via the knock sensors 23 and/or crankshaft sensors 66, and sending signals indicative of the operating conditions to the controller 25 (block 142). For example, each cylinder 26 (or a subset of cylinders 26) may include a knock sensor 23, a crankshaft sensor 66, or both coupled to, or disposed proximate to, the cylinder 26 (or the subset of cylinders 26). The knock sensor 23 may monitor vibrations of the corresponding cylinder 26 (or of components in the corresponding cylinder 26), which may be indicative of varying pressures within the cylinder 26 (e.g., within the combustion chamber 12 of the cylinder 26). The crankshaft sensor 66 may monitor a position of the crankshaft 54 coupled to the piston 20 in the cylinder 26 (e.g., via the connecting rod 56), or the crankshaft sensor 66 may monitor an angular velocity of the crankshaft 66. The knock sensor 23 and/or the crankshaft sensor 66 (e.g., for each cylinder 26, or each subset of cylinders 26) may send signals to the controller 25 with data indicative of the operating conditions sampled by the knock sensor 23 and/or the crankshaft sensor 66.

The process 140 also includes determining (e.g., via the controller 25), whether the signals from the knock sensors 23 and/or the crankshaft sensors 66 indicate a change (e.g., rise) in operating peak firing pressure in one or more of the cylinders 26 (block 142). For example, as previously described, the controller 25 may detect changes (e.g., rises) in peak firing pressure in one or more of the cylinders 26 by analyzing the knock sensor 23 signals alone (e.g., by comparing the signals with a baseline peak firing pressure value, as previously described, or by comparing the signals with each other over a number of cycles), the crankshaft sensor 66 signals alone (e.g., by comparing the signals with a baseline angular velocity value, or by comparing the signals with each other over a number of cycles), or both in conjunction with one another. In doing so, the controller 25 may determine (a) if any of the cylinders 26 include a change (e.g., rise) in peak firing pressure, (b) how many of the cylinders 26 include a change (e.g., rise) in peak firing pressure, and (c) which of the cylinders 26 (or subset of cylinders 26) include(s) a change (e.g., rise) in peak firing pressure.

If the controller 25 determines that no change (e.g., rise) in peak firing pressure has occurred in any of the cylinders 26 (block 146), block 142 is repeated. If the controller 25 determines that a change (e.g., rise) in peak firing pressure has occurred in at least one of the cylinders 26 (block 148), the controller 25 then analyzes the signals to determine how many cylinders 26 include a change (e.g., rise) in peak firing pressure, and, in some embodiments, which cylinders 26 include the change(s) (block 150). For example, the controller 25 determines which signals correspond with which cylinders 26 (or subset of cylinders 26). Accordingly, the controller 25 may determine which of the cylinders 26 (or subset of cylinders 26) includes a change (e.g., rise) in peak firing pressure. If only one of the cylinders 26 includes a change (e.g., rise) in peak firing pressure (block 152), the change (e.g., rise) in peak firing pressure is considered a local event (e.g., affecting only one cylinder). Accordingly, the controller 25 may determine that the cause of the change (e.g., rise) in operating peak firing pressure in the one cylinder 26 is due to conditions that do not affect all the cylinders 26, which would be considered a global event (e.g., affecting all the cylinders).

The controller 25 may diagnose the problem, then, as being related to oil coking, fuel coking, or compression ratio change (e.g., without analyzing other signals from other control feedback components which may be indicative of global events, such as the air sensors 27 [in some embodiments] or the electrical load control feedback component 104) (block 154). However, in certain embodiments, the process 140 may include an optional step of determining whether the knock sensor 23 signal for the cylinder 16 having a change (e.g., rise) in peak firing pressure corresponds with the crankshaft sensor 66 signal for the same cylinder 26 (block 156). For example, as previously described, in certain embodiments only one of the signals from the knock sensor 23 and crankshaft sensor 66 may be needed to detect a change (e.g., rise) in peak firing pressure. Accordingly, after detecting the change (e.g., rise) in peak firing pressure in only one of the cylinders 26 (e.g., by analyzing the knock sensor signal 23 or the crankshaft sensor 66 signal), the controller 25 may confirm the detection of the change (e.g., rise) in peak firing pressure in the only one cylinder 26 (e.g., by analyzing the other of the crankshaft sensor 66 signal and the knock sensor 23 signal) by determining that the signals correspond with each other (e.g., both signals indicate a change [e.g., rise] in peak firing pressure) (block 158).

If the controller 25 determines that a change (e.g., rise) in peak firing pressure has occurred in more than one of the cylinders 26 but not in all of the cylinders 26 (block 160), the controller 25 may diagnose the problem as being related to oil coking or compression ratio changes in the cylinders 26 (block 162). For example, because the cause of the change (e.g., rise) in peak firing pressure is not a global event (which, for example, would affect all the cylinders 26), the controller 25 determines that the cause is a local or semi-local event (e.g., affecting one or a subset of the cylinders 26, respectively). Similar to blocks 156 and 156, the controller 25 may confirm the changes (e.g., rises) in the cylinders 26 by analyzing the knock sensor 23 signals and the crankshaft sensor 66 signals (blocks 164 and 166, respectively). It should be noted that, in some embodiments, one or more of the cylinders 26 may receive (and combust) an air-fuel mixture 32 having an undesirable ratio of air 16 to fuel 18, which may also cause a change (e.g., rise) in peak firing pressure, and which may also be considered a local event. In such embodiments, the controller 25 may receive signals from air sensors 27 associated with each cylinder 26, where the air sensors 27 sample for readings of the oxygen content (or other conditions indicative of oxygen content) in the exhaust expelled from each cylinder 26. The air sensors 27 may send signals indicative of the oxygen content in the exhaust to the controller 25, such that the controller 25 may determine, based on the oxygen content levels, whether one or more of the cylinders 26 includes an undesirable ratio of air 16 to fuel 18 in the air-fuel mixture 32. This embodiment will be described in detail with reference to FIG. 5 and block 200.

Turning now to FIG. 4B, if the controller 25 determines that all the cylinders 26 include a change (e.g., rise) in peak firing pressure (block 170), the controller 25 may determine that the change (e.g., rise) in peak firing pressure is a global event (e.g., affecting all the cylinders 26). The controller 25 may receive a signal from one air sensor 27 that samples conditions of the ambient air in which the reciprocating engine 10 operates (block 172). For example, the air sensor 17 may monitor a pressure of the ambient air, a temperature of the ambient air, or any other suitable property of the ambient air. The controller 15 may receive signals from the air sensor 17 and determine whether the signals indicate a change in the ambient air conditions or, more specifically, whether the signals indicate undesirable ambient air conditions (e.g., temperature is too high, temperature is too low, pressure is too high, pressure is too low, etc.) (block 174). For example, the controller 25 may compare the ambient air conditions indicated by the data in the signals received from the air sensors 27 with a baseline (e.g., threshold, desired, maximum, maximum desired) value of the ambient air conditions. If the controller 25 determines that ambient air conditions have changed or are not desirable (block 176), the controller 25 diagnoses the cause of the change (e.g., rise) in peak firing pressure in all the cylinders 26 of the engine 10 as being related to the undesirable ambient air conditions (block 178).

If the controller 25 determines that the ambient air conditions are not undesirable, or that the ambient air conditions have not changed (block 180), the electrical load control feedback component 104 may transmit a signal to the controller 25, where the signal includes data indicative of an amount of electrical load being drawn from the engine 10 (block 182). However, it should be noted that the signal from the electrical load control feedback component 104 may be sent to the controller 25 and received by the controller 25, and analyzed by the controller 25, regardless of whether the previous steps described in the process 140 are performed, and at any time.

In accordance with the present disclosure, the controller 25 then determines whether the signal indicates a change in the amount of electrical load being drawn from the engine 10, and/or whether the amount of electrical loading is too large (block 184). For example, in certain embodiments, the reciprocating engine 10 may be configured to operate at or below a particular maximum electrical load threshold (e.g., baseline value). Exceeding the maximum electrical load threshold (e.g., baseline value) may cause changes (e.g., rises) in peak firing pressure in the cylinders 26 of the reciprocating engine 10. Accordingly, if all the cylinders 26 include a change (e.g., rise) in peak firing pressure (e.g., as determined by the controller 25 upon analyzing the signals from the knock sensors 23 and/or crankshaft sensors 66), and the signal(s) from the electrical load feedback component 104 indicates that the amount of electrical load being drawn from the engine 10 has increased or changed too much (block 186), the controller 25 may determine (e.g., diagnose) that the change (e.g., rise) in operating peak firing pressure in all the cylinders 26 is caused by the change (e.g., rise) in electrical load (block 188). If all the cylinders 26 include a change (e.g., rise) in peak firing pressure but the controller 25 determines that ambient air conditions and electrical loading are not the cause(s) of the change (block 190), the controller 25 may determine (e.g., diagnose) that the cause of the change (e.g., rise) in peak firing pressure in all the cylinders 26 is related to oil cooking, compression ratio rise in all the cylinders 26, or a change in fuel quality of the fuel supplied to each of the cylinders 26 (e.g., which is supplied via a common manifold to all the cylinders 26) (block 192).

It should be noted, however, that signals received from the electrical feedback component 104 may be analyzed by the controller 25 relative to other operating conditions described above and below (e.g., relating to local and/or semi-local events), and that an increase in electrical loading above the threshold may cause a change (e.g., rise) in operating peak firing pressure in less than all the cylinders 26 of the engine 10 (e.g., in one or in a subset of cylinders 26). Accordingly, in some embodiments, the controller 25 may analyze data from the electrical loading feedback component 104 at any time, and/or following detection of a change (e.g., rise) in operating peak firing pressure in any number of cylinders 26 of the engine 10. Indeed, depending on the embodiment, the controller 25 may analyze any and all signals described herein from any and all corresponding sensors/feedback components to detect a change (e.g., rise) in peak firing pressure, and to diagnose a cause of the change, regardless of the number of cylinders 26 having the change.

As previously described, other factors may cause a change (e.g., rise) in peak firing pressure in one or more of the cylinders 26. For example, FIG. 5 is a process 200 (e.g., continuing from the process 140 of FIGS. 4A and 4B) in which the controller 25 receives signals from multiple air sensors 27, each air sensor 27 being communicatively coupled with a corresponding cylinder 26 or corresponding subset of cylinders 26. For example, after analyzing signals from the knock sensors 23, the crankshaft sensors 66, or a combination thereof (e.g., to detect the change [e.g., rise] in peak firing pressure), the controller 25 may receive signals from a group of air sensors 27 (e.g., oxygen sensors), each air sensor 27 being configured to detect conditions of exhaust expelled from a corresponding one of the cylinders 26 (or a corresponding group or subset of the cylinders 26). In other words, each air sensor 27 monitors (e.g., samples) exhaust conditions of a corresponding cylinder 26 or corresponding group of cylinders 26 (block 202). The air sensors 27 may detect an amount of oxygen present in the exhaust, and may transmit signals indicative of the oxygen content to the controller 25.

The controller 25 may analyze the signals to determine whether the oxygen content is too high or too low (e.g., relative to a threshold value, maximum value, desired value, maximum desired value, baseline value, etc.) in the exhaust of each cylinder 26 (or of each group of cylinders 26) having the change (e.g., rise) in peak firing pressure (block 204). It should be noted that the controller 25 may analyze the air sensor 27 signals for situations in which only one cylinder 26 includes a change (e.g., rise) in peak firing pressure, more than one but not all of the cylinders 26 include changes (e.g., rises) in peak firing pressure, or all of the cylinders 26 include changes (e.g., rises) in peak firing pressure, as indicated in FIG. 4. In general, the controller 25 detects the change or changes (e.g., rise or rises) in peak firing pressure in one or more cylinders 26 by analyzing the signals from the knock sensors 23 and/or crankshaft sensors 66, and then diagnoses the cause of the change or changes (e.g., rise or rises) by analyzing the air sensors 27 (and/or, in some embodiments, the air sensor 27 configured to monitor ambient air conditions, the electrical power feedback component 104, and other feedback components described in detail above).

If the controller 25 determines that the oxygen content in the exhaust expelled from the cylinders 26 in question (e.g., having a rise in operating peak firing pressure) is appropriate (e.g., the oxygen content or other chemical content is not too high or too low) (block 206), the controller 25 provides one of the diagnoses in blocks 154, 162, or 172, as appropriate, and as described in detail above with reference to FIG. 4 (e.g., depending on the number of cylinders 26 having a change [or rise] in peak firing pressure) (block 208). If the controller 25 determines that the oxygen content in the exhaust expelled from the cylinders 26 in question is not appropriate (e.g., the oxygen content is too high or too low) (block 210), the controller 25 may diagnose the cause of the change (e.g., rise) in operating peak firing pressure in the one or more cylinders 26 as being related to undesirable ratios of air 16 to fuel 18 in the air-fuel mixture 32 combusted in the combustion chambers 12 of the cylinders 26 in question, which is generally indicated by the oxygen content in the exhaust (block 212).

In general, systems and methods in accordance with the present disclosure are directed to detecting changes (e.g., rises) in operating peak firing pressure in cylinders of a reciprocating engine, and diagnosing a cause of the changes (e.g., rises) in operating peak firing pressure. Feedback components (e.g., sensors such as knock sensors, crankshaft sensors, air sensors, etc.) may provide signals indicative of measurements of operating conditions of the cylinder to a controller. The controller may analyze one or more of the signals to detect a change (e.g., rise) in peak firing pressure in at least one of the cylinders. The controller may analyze any number of additional signals to diagnose a cause of the change (e.g., rise) in peak firing pressure in the at least one cylinder. To detect the change (e.g., rise) in peak firing pressure, the controller may analyze knock sensor signals, crankshaft sensor signals, or both. To diagnose the cause of the change in peak firing pressure, the controller may analyze knock sensor signals, crankshaft sensor signals, air sensor signals, and/or data relating to electrical loading of the engine. The controller may diagnose the cause of the change as a local event (e.g., affecting one cylinder), a semi-local event (e.g., affecting more than one but not all of the cylinders), or a global event (e.g., affecting all the cylinders), and may diagnose the cause of the change as relating to oil coking, compression ratio change, fuel quality change, undesirable ambient air conditions, undesirable ratio of air to fuel in the air-fuel mixture, or some other cause.

This written description uses examples to disclose the present disclosure, including the best mode, and also to enable any person skilled in the art to practice the disclosure, including making and using any devices or systems and performing any incorporated methods. The patentable scope of the present disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
a control system configured to monitor operating conditions in at least a first and a second cylinder of a reciprocating engine, wherein the control system comprises:
a first sensor configured to monitor a first type of operating condition of the first cylinder;
a second sensor configured to monitor the first type of operating condition of the second cylinder;
at least one feedback component configured to monitor a second type of operating condition of the reciprocating engine; and
a controller communicatively coupled with the first sensor, the second sensor, and the at least one feedback component, wherein the controller is configured to receive a first signal indicative of a first measurement of the first type of operating condition from the first sensor, a second signal indicative of a second measurement of the first type of operating condition from the second sensor, and a third signal indicative of a third measurement of the second type of operating condition of the reciprocating engine from the at least one feedback component, wherein the controller is configured to analyze the first and second signals to detect a change in operating peak firing pressure in the first cylinder, in the second cylinder, or in a combination thereof, and wherein the controller is configured to analyze the third signal to diagnose a cause of the change in operating peak firing pressure in the first cylinder, in the second cylinder, or in the combination thereof.

2. The system of claim 1, wherein the first sensor comprises a first knock sensor and the second sensor comprises a second knock sensor.

3. The system of claim 2, wherein the at least one feedback component comprises an air sensor configured to monitor ambient air conditions proximate to the reciprocating engine.

4. The system of claim 2, wherein the at least one feedback component comprises a first feedback component and a second feedback component, wherein the first feedback component comprises a first air sensor configured to monitor oxygen content in an exhaust of the first cylinder, and wherein the second feedback component comprises a second air sensor configured to monitor oxygen content in an exhaust of the second cylinder.

5. The system of claim 2, wherein the at least one feedback component is configured to monitor an electrical load drawn from the reciprocating engine.

6. The system of claim 1, wherein the first sensor is a first crankshaft sensor and the second sensor is a second crankshaft sensor.

7. The system of claim 6, wherein the at least one feedback component is an air sensor configured to monitor ambient air conditions proximate to the reciprocating engine.

8. The system of claim 6, wherein the at least one feedback component comprises:
a first air sensor configured to monitor oxygen content in an exhaust of the first cylinder; and
a second air sensor configured to monitor oxygen content in an exhaust of the second cylinder.

9. The system of claim 6, wherein the at least one feedback component is configured to monitor an electrical load drawn from the reciprocating engine.

10. A method of monitoring cylinders of an engine, comprising:
receiving, via an engine controller, a plurality of signals indicative of a first operating condition in the cylinders of the engine;
determining, via the engine controller, whether the plurality of signals indicative of the first operating condition in the cylinders of the engine indicate a change in operating peak firing pressures in one or more cylinder of the engine;
receiving, via the engine controller, at least one second signal indicative of a second operating condition of the engine; and
diagnosing, via the engine controller based on analyzing the at least one second signal, a cause of the change in operating peak firing pressures in the one or more cylinders of the engine.

11. The method of claim 10, wherein receiving, via the engine controller, the plurality of signals indicative of the first operating condition in the cylinders of the engine comprises:
receiving a plurality of knock sensor signals from a plurality of knock sensors communicatively coupled with the cylinders of the engine; or receiving a plurality of crankshaft sensor signals from a plurality of crankshaft sensors communicatively coupled with the cylinders of the engine; and
wherein receiving, via the controller, the at least one second signal indicative of the second operating condition of the engine comprises:
receiving at least one signal indicative of ambient air conditions from at least one air sensor;
receiving at least one signal indicative of electrical loading of the engine from at least one electrical loading feedback component; or
receiving a plurality of air sensor signals indicative of oxygen content in exhaust from the cylinders of the engine.

12. A control system comprising:
a first plurality of sensors configured to monitor a first operating condition in a corresponding plurality of cylinders of a reciprocating engine;
a controller communicatively coupled with the first plurality of sensors, wherein the controller is configured to receive a first plurality of signals indicative of the first operating condition from the first plurality of sensors to receive at least one second signal indicative of at least one second operating condition of the reciprocating engine, to analyze the first plurality of signals to detect a change in operating peak firing pressure in one or more cylinders of the plurality of cylinders, and to analyze the at least one second signal indicative of the at least one second operating condition of the reciprocating engine to diagnose a cause of the change in operating peak firing pressure in the one or more cylinders of the plurality of cylinders.

13. The control system of claim 12, wherein the control system comprises a second plurality of sensors configured to monitor a second operating condition in the corresponding plurality of cylinders of the reciprocating engine, and wherein the at least one second signal comprises a second plurality of signals indicative of the second operating condition in the plurality of cylinders.

14. The control system of claim 13, wherein the first plurality of sensors comprises a first plurality of knock sensors.

15. The control system of claim 14, wherein the second plurality of sensors comprises a second plurality of crankshaft sensors.

16. The control system of claim 14, wherein the second plurality of sensors comprises a second plurality of air sensors.

17. The control system of claim 13, wherein the first plurality of sensors comprises a first plurality of crankshaft sensors.

18. The control system of claim 17, wherein the second plurality of sensors comprises a second plurality of air sensors.

19. The control system of claim 12, wherein the at least one second signal indicative of the at least one second operating condition is indicative of an amount of electrical load drawn from the reciprocating engine, and wherein the controller is configured to analyze the amount of electrical load drawn from the reciprocating engine to diagnose the cause of the change in operating peak firing pressure in the one or more cylinders of the plurality of cylinders.

20. The control system of claim 12, wherein the controller is capable of diagnosing the cause of the change in operating peak firing pressure as oil coking or compression ratio changes, ambient air changes, fuel quality improvement or decline, and rise in electrical loading.
